(19) United States
(12) Patent Application Publication
(10) Pub. No.: US 2007/0052312 A1
(43) Pub. Date: Mar. 8, 2007

(54) Permanent magnetic motor

(76) Inventors: Anatoliy Stanetskiy, Brooklyn, NY (US); Dmytro Stanetskiy, Brooklyn, NY (US)

Correspondence Address: Anatoliy Stanetskiy, 2450 85th Street, #2F, Brooklyn, NY, 11214, US

(21) Appl. No.: 11/222,192

(22) Filed: Sep. 8, 2005

(51) Int. Cl. H02K 21/00; H02K 21/12

(52) U.S. Cl. 310/152; 310/156.43

(57) ABSTRACT

A motor in different embodiments with a rotatable torque created by permanent magnets having stator and rotor assemblies, each comprising peripherally disposed permanent magnets spaced apart with soft iron insertions filled therebetween, both shaped and magnetized so that producing predominantly mono-polar field in an airgap between each pair of interfacing rotor and stator assemblies, the airgap widening from the first to last magnet of stator; which magnets specifically superimposed forming a connecting magnet; the connecting magnets of different stator assemblies relatively located at a predetermined angle, and the numbers of assemblies magnets having no common multiple. Said permanent magnets are shaped as annular segments of one-thread radial or three-dimensional spirals, said insertions are shaped as three-planeside prisms. The compressional embodiment comprises an immovable lower stator assembly, a rotor and upper stator assembly both capable of vertical displacement regulated by a mechanism, varying the airgap, increasing or reducing the rotatable torque.

### TECHNICAL FIELD

The present invention-relates to permanent magnetic motors, that is devices capable to produce a propulsion or motive force to power conventional mechanisms by utilizing the energy accumulated in permanent magnets.

### BACKGROUND OF THE INVENTION

As known, permanent magnets are widely used in constructions of electromagnetic generators and engines. Some examples are the following U.S. patents and application publication:
5,585,680 to Tsoffka disclosing an electromagnetic stepper motor comprising a rotor having a plurality of permanent magnets and a stator having a plurality of permanent magnets and electromagnets connected to a commutator for creation of additional pushing actions to provide continuous rotation of the rotor;
5,847,482 to Tsofka disclosing an electromagnetic stepper motor comprising a rotor having a plurality of electromagnets and a stator surrounding the rotor and having a plurality of permanent magnets particularly spaced from the outer surface of the rotor so that a distance between them decreases in direction of rotation of the rotor and a plurality of screening elements located forwardly of the stator's permanent magnets for compensation of magnetic attraction of the rotor by the stator within the pause of electric current in the electromagnets;
6,049,153 to Nashiki describing a permanent magnetic motor, comprising a three-phase stator and a rotor having a plurality of permanent magnets, basically dedicated to an increase of the change rate d.phi./d.theta of the rotation of flux linked to the stator winding and to an increase of the generated rotational torque of the motor proportional to the flux density of the permanent magnet by means of a special configuration of the permanent magnets;
6,163,097 to Smith describing in particular an axial field motor/generator having a rotor that includes at least three annular discs magnetized to provide multiple sector-shaped poles, and a stator that includes a stator assembly between each two adjacent magnets, wherein the stator assembly includes one or more conductors or windings;
6,181,047 to Nitta particularly providing a permanent magnetic motor with improved stator core, in which the vibration and noise due to the variations in the electromagnetic force can be restrained, which is basically achieved by special construction of the stator teeth, including a first type of tooth having a head faced opposed to the rotor and shaped as an arc about a center of rotation of the rotor so that an air gap between the tooth and the rotor surface opposed to the tooth is circumferentially uniform, and including a second type of tooth having a head faced opposed to the rotor and shaped so as to be gradually departed farther away from an opposite surface of the rotor as the head extends from its circumferentially central portion toward both circumferential ends;
6,262,507 to Sato et al, teaching a permanent magnet motor, having a rotor in the form of a multi polar-magnetized cylindrical permanent magnet and a stator having a plurality of stator teeth, wherein the cylindrical permanent magnet has a direction of orientation along a single diameter of the cylinder that is perpendicular to the cylinder axis when a definite relationship is held between the number of the multi-polar magnetic poles and the number of the stator teeth. When desired, two or more of the cylindrical unit permanent magnets each having a single diametrical orientation are coaxially stacked one on the other into a block in such a relative disposition that the directions of two adjacent cylindrical unit permanent magnets make a rotational displacement angle of 180.degree. divided by the number of the unit magnets;
U.S. patent application publication 2002/0003382 by Nakano et al, describing a permanent magnet motor having a rotor with a plurality of permanent magnets disposed on the outer circumferential face at a predetermined interval in a peripheral direction, and a stator with a plurality of magnetic pole pieces arranged at a predetermined spacing in the peripheral direction, the magnetic pole pieces being opposed to the permanent magnets, the stator surrounding the rotor, wherein the auxiliary grooves are provided on a face of each magnetic pole piece of the stator opposed to the permanent magnets of the rotor, and a skew having an electric angle of 72.degree. is provided relatively between the rotor and the stator.

All the above mentioned machines include windings or electric current conducting means to achieve their respective objectives. There are also solutions based on the exclusive use of permanent magnets for creation a motive linear force or rotational torque in the stator units and in the rotor units (moving armature). Such examples are especially following:
U.S. patent 4,151,431 to Howard Johnson, disclosing the invention providing the proper combination of materials, geometry and magnetic concentration to utilize the force generated in permanent magnets to power a motor. The “stator” may consist of a plurality of permanent magnets fixed relative to each other in space relationship to define a track, linear in form in the linear embodiment, and circular in form in the rotary embodiment. An armature magnet is located in spaced relationship to such track defined by the stator magnets wherein an air gap exists therebetween. The continuing motive force results from the relationship of the length of the armature magnet as related to the dimension of the stator magnets, and the spacing therebetween. This ratio of magnet and magnet spacings and acceptable air gap spacing between the stator and armature magnets, produces a resultant force upon the armature magnet, which displaces the armature magnet across the stator magnet along its path of movement. In the rotary embodiment of the permanent magnet motor of the invention the stator magnets are arranged in a circle, and the armature magnets rotate about the stator magnets. Means are disclosed for producing relative axial displacement between the stator and armature magnets to adjust the axial alignment thereof, and thereby regulate the magnitude of the magnetic forces being imposed upon the armature magnets. In this manner the speed of rotation of the rotary embodiment may be regulated;
U.S. Pat. No. 4,877,983 to Howard Johnson, disclosing a permanent magnet armature, magnetically propelled along a guided path by interaction with the field within a flux zone limited on either side of the path by an arrangement of permanent stator magnets. The invention provides certain improved stator arrangements of permanent magnets interacting with a permanent magnet armature for unidirectional propulsion thereof in a more efficient manner;
U.S. Pat. No. 5,402,021 to Howard Johnson, disclosing a propulsion system including two parallel walls of permanent magnets arranged so as to define the lateral sides of a vehicle path. The walls are identical to one another except that the polarities of the magnets of one wall are opposite from the polarities of the corresponding magnets in the opposite wall. The first wall includes a series of rectangular magnets, each arranged with a North-to-South axis pointing longitudinally down the wall in the intended direction of vehicle travel. Each of the rectangular magnets is separated from the next successive rectangular magnet by a thinner magnet, which thinner magnet is arranged with its North-to-South axis pointing laterally toward the opposite wall and therefor perpindicular with respect to the North-to-South axis of the rectangular magnets. The second wall includes the same general arrangement of magnets, except that the North-to-South axis for each of the generally rectangular magnets is in a direction opposite from the direction of vehicle travel and the North-to-South axis of the thinner magnets points away from the first wall.

Having analyzed the latter constructions, it can be noticed, that while they define a novel class of permanent magnetic motors, the rotatable torque developed by them so far is insufficient to move and empower conventional mechanisms or drives. It is believed, they have a common problem causing such insufficiency. According to Johnson's patent 4,151,431, the armature magnet is disposed relative to the track defined by the stator magnets in the direction of the path of movement of the armature magnet as displaced by the magnetic forces. The stator magnets are so mounted that poles of like polarity are disposed toward the armature magnet and as the armature magnet has poles which are both attracted to and repelled by the adjacent pole of the stator magnets, both attraction and repulsion forces act upon the armature magnet to produce the relative displacement between the armature and stator magnets. Therefore, when both the attraction and repulsion forces act upon the armature magnet, the resultant force is substantially the difference of those two and may not produce a significant motive force or rotatable torque. Additionally, the resultant force or rotatable torque is unequally distributed along the path of the armature movement or in the air gap between the stator and the rotor toward the rotor rotation, having a plurality of critical points with low positive (or sometimes even negative) values of such resultant force or torque. Thus, the problem is nested in that the magnetic field formed in the air gap in those machines has a predominantly bi-polar distribution, which creates the condition for acting of the two antagonist forces.

### BRIEF SUMMARY OF THE INVENTION

One of the aims of this invention is to provide a new motor deploying exclusively permanent magnets, and capable to produce a linear motive force or rotatable torque substantially sufficient to power mechanisms and drives for useful applications.

Another aim of the invention is to provide a special configuration of the magnetic field to be created by said motor in the air gap between its stator's and rotor's (armature's) permanent magnets; which configuration is characterized in that it has a predominantly mono-polar distribution of the magnetic forces, while the opposite polarity magnetic forces are substantially limited to predetermined small areas, of the air gap, so that do not essentially affect the interaction of the stator's and rotor's (armature's) permanent magnets. This configuration should also cause a significant and substantially unidirectional motive force or rotatable torque oriented toward the path of the armature movement or the rotation of rotor, and largely reduce the loss of power to overcome the aforementioned critical points.

Another aim of the invention is to provide a novel and unobvious combination of means for creation of said configuration of the magnetic field in the form of special shapes, spacing arrangements and orientations of such means, as well as certain relationships between the numbers of members combined in said means.

Another aim of the invention is to provide a multi-stator and multi-rotor constructions of said motor, capable to significantly magnify its rotatable torque.

Another aim of the invention is to provide control means for regulation of the rotatable torque and speed of rotation of the rotor.

Other aims of the invention will become apparent from a consideration of the drawings, ensuing description, and claims as hereinafter related.

The description of the invention, discussed herein below, will show the following advantages of said motor:
the motor, comprising exclusively permanent magnets and non-magnetic insertions positioned on the stator and the rotor, and deploying the mentioned predominantly mono-polar distribution of the magnetic forces inside its air gap, is capable to achieve the motive force or rotatable torque unavailable for the existing constructions of similar motors known in the prior art;
such motive force or rotatable torque is sufficient to drive conventional mechanisms, including electrical generators and transportation means, that is to be used for different useful real-life applications wherever linear or rotational motors are suitable;
the motor may be utilized in the areas or under circumstances where there is a shortage of conventional fuels and electric power;
other advantages of the present invention may be found and appreciated by anyone intending to use and practicing the permanent magnetic motor.

The mentioned aims and advantages are achieved by providing three embodiments of a permanent magnetic motor (PMM), which is the subject matter of the present invention.

The first disclosed embodiment is a radial PMM having an inner stator assembly; a rotor surrounding the inner stator assembly, including two rotor assemblies: inner and outer adjacently situated and coupled to each other; an outer stator assembly surrounding the rotor. All the assemblies are positioned concentrically. The stator assemblies are mounted immovably. The rotor is capable to rotate around a pivotally secured vertical axle.

The rotor assemblies each is performed as a circumferential row of permanent magnets, separated by insertions made of soft iron capable to acquire induced magnetism wherever in a contact with a permanent magnet. The stator assemblies are shaped as a substantially horizontally oriented spiral forming a horizontally measured air gap between the stator assembly and the corresponding counterpart rotor assembly facing each other. The air gap continuously widens (e.g. clockwise), forming an inter-joint area at the end of the stator assembly. The stator assemblies each comprises a spiral row of permanent magnets, separated by similar soft iron insertions, except the first magnet of the assembly is partially superimposed on and properly connected to the last magnet forming a connecting magnet.

The permanent magnets of the radial stator and rotor assemblies are shaped as an annular segment, having two plane vertical sides, two cylindrical vertical sides, and two horizontal bases. The insertions have a shape of a three-side prism positioned vertically. The insertions substantially completely fill the empty spaces between the permanent magnets, except between the first and the last magnets of the stator assemblies, as indicated above.

The permanent magnets of the stator and rotor assemblies facing each other are magnetized with the same polarity and create a predominant mono-polar (e.g. N) magnetic field zone in the air gap. The soft iron insertions provide a redistribution of the concentration of magnetic flux, so that a zone of the opposite polarity (e.g. S) will be essentially restricted to a predetermined relatively small area in the proximity of the insertion's rib situated on the respective assembly's surface facing the air gap. The air gaps between the rotor and stator should have a minimal possible width to achieve a greater rotational torque.

The concentration of magnetic fields of the predominant mono-polar zones in the air gaps between the stator and rotor decreases in the direction of widening of the air gaps, which creates a rotational repulsive force applied toward said direction. The aforementioned inter-joint area is characterized in that the repulsive force within the area generally changes its direction to the contrary, i.e. negative.

For substantial reduction of the negative repulsive force, the first and last magnets of the spiral stator assembly are partially superimposed and properly connected, forming the connecting magnet with a length greater than a critical length of permanent magnet. The critical length may be determined for an elongated permanent magnet as the minimum length of the magnet, which provides a substantially zero magnet force around the middle area of the magnet. Therefore, the connecting magnet provides a transitional zone of zero magnetic field between the point of maximum air gap and the point of minimum air gap of the stator assembly.

After a rotor magnet passes the zero zone, the remaining portion of the connecting stator magnet (a critical portion) still causes the negative repulsive force decelerating the magnet, until the half point of the rotor magnet passes the critical portion of the connecting magnet. At this point the positive motive force will be applied to the rotor magnet further accelerating it.

An additional reduction of the negative repulsive force is provided by positioning the inter-joint areas of two stator assemblies at an angle equal 180.degree., or at 360.degree. divided by ‘n’, if the number of stator assemblies is equal to ‘n’. The numbers of permanent magnets of the rotor and stator assemblies of the PMM must not have a common multiple. This excludes the passing of the critical portions of two stator connecting magnets, mounted on the different stator assemblies, by two rotor magnets simultaneously. While one of the two rotor magnets, positioned opposite (at 180.degree.) to each other, enters the critical portion of connecting magnet of one stator assembly, the second (opposite) rotor magnet has already passed the critical portion of connecting magnet of the other stator assembly and starts accelerating, or vice versa. Therefore, the PMM provides continuous rotation of the rotor.

The second disclosed embodiment is an axial PMM, comprising a rotor capable to rotate around a pivotally secured vertical axle. The exemplified rotor includes two (upper and lower) annularly shaped rotor assemblies vertically and continuously fixed to each other. The axial PMM comprises at least two stator assemblies (upper and lower) each shaped as a helix, immovably disposed above and below the rotor.

A plurality of permanent magnets and a plurality of insertions similar to those in the radial embodiment are circumferentially (or peripherally) and adjacently disposed on the rotor (or respectively on the stator) assemblies, forming a vertically measured air gap between the upper (or the lower) stator assembly and the lower (or respectively the upper) rotor assemblies correspondingly facing said stator assemblies. The air gap continuously widens (e.g. clockwise), forming an inter-joint area at the end of the stator assembly.

The shape of each permanent magnet is essentially an annular segment with two skewed plane sides (left and right) where the upper line of each plane side extends parallel to the corresponding lower line of the plane side and the longer of those two lines is oriented radially in the horizontal plane which it is situated on, two cylindrical vertical sides, two horizontal bases. Each insertion is shaped as a three-side prism disposed horizontally. The left and right sides of each permanent magnet are joined by the respective right and left sides of the two adjacent insertions separating two neighboring permanent magnets. Thus the insertions substantially completely fill the empty space between each two rotor neighboring permanent magnets. The insertions substantially completely fill the empty space between each two stator neighboring permanent magnets, except the first magnet of the stator assembly is partially superimposed on and properly connected to the last magnet forming a connecting magnet.

The principles of operation of the axial PMM are similar to the ones of the radial PMM.

The third disclosed embodiment is a compressional PMM, wherein the rotor and stator are essentially performed similarly to the axial embodiment, except that the rotor and the upper stator assembly are made vertically displaceable, which displacement can be regulated by a special mechanism.

The exemplified compressional PMM comprises: a casing, its upper cover with several holes, a lower flange fixed to the cover, a bolt disposed vertically with the treads on its top, a nut properly put on the threads of the bolt, so as having a direct contact with the upper surface of an upper flange fixed on top of the cover, which upper flange having a through hole wherein the bolt is inserted, several pins vertically and downwardly attached to the upper flange and capable to vertically slide through the holes of the cover; a shaft vertically and pivotally installed in an upper bearing mounted on the cover and in a lower bearing mounted on the bottom of the casing, a number of shaft keyway vertically made on the shaft; a nave horizontally disposed on the shaft and connected to the shaft by a straight sunk key attached to the nave, where key is slidely displaceable on one of the shaft keyway, allowing the nave to vertically slide on the shaft; a lower stator assembly mounted on a lower support rim immovably fixed to the bottom of the casing; lower and upper rotor assemblies peripherally mounted on the nave; an upper stator assembly mounted on an upper support rim, slidely disposed on a plurality of casing grooves vertically made on the casing walls; a disk positioned on top of the upper stator assembly, so that the pins are capable to displace the disk downward transmitting a pressure of the nut and the upper flange.

The disk with the pins and the upper stator assembly displace downward until the increasing repulsive magnetic force in the air gap between the stator and rotor assemblies compensates the gravitation force. The rotor with the nave and the shaft start rotating pushed by the repulsive magnetic forces in the air gaps. Since these forces depend on the concentration of the magnetic flux in the air gap, a reduction of the width of the air gap causes an increase of the flux concentration, and thus magnifies the rotatable torque and speed of rotation of the rotor. It is therefore possible to turn down the nut imposing a pressure on the upper flange, the pins, and the disk, to additionally displace the upper stator assembly downward for further decreasing the air gap, and increasing the concentration of flux and the rotational torque of the PMM. Consequently, the compressional embodiment enables the operator to regulate the speed and rotational torque of the permanent magnetic motor.

### BRIEF DESCRIPTION OF THE DRAWINGS

FIG. 1 is a layout schema demonstrating the principles of the present invention.

FIG. 2 is a plan sectional view of the invented permanent magnetic motor in the radial embodiment.

FIG. 3 is an isometric schematic view of two stator assemblies and a rotor assembly demonstrating their mutual disposition in the axial embodiment of the of the invented permanent magnetic motor.

FIG. 4 is a frontal sectional view of the invented permanent magnetic motor in the compressional embodiment.

FIG. 5 is an isometric sectional view of in the compression embodiment of the invented permanent magnetic motor.

FIG. 6 is an exploded isometric view of four stator assemblies and two rotor assembly on a common shaft in the compressional embodiment of the invented permanent magnetic motor.

FIG. 7 is a detail isometric view of the rotor permanent magnet in the radial embodiment.

FIG. 8 is a detail isometric view of the rotor soft iron insertion in the radial embodiment.

FIG. 9 is a detail isometric view of the stator permanent magnet in the radial embodiment.

FIG. 10 is a detail isometric view of the stator soft iron insertion in the radial embodiment.

FIG. 11 is a detail isometric view of the rotor permanent magnet in the axial embodiment.

FIG. 12 is a detail isometric view of the rotor soft iron insertion in the axial embodiment.

FIG. 13 is a detail isometric view of the stator permanent magnet in the axial embodiment.

FIG. 14 is a detail isometric view of the stator soft iron insertion in the axial

### DESCRIPTION AND OPERATION OF THE INVENTION

While the invention may be susceptible to embodiment in different forms, there is shown in the drawings, and will be described in detail herein, three specific embodiments of the present invention, with the understanding that the present disclosure is to be considered an exemplification of the principles of the invention, and is not intended to limit the invention to that as illustrated and described herein.

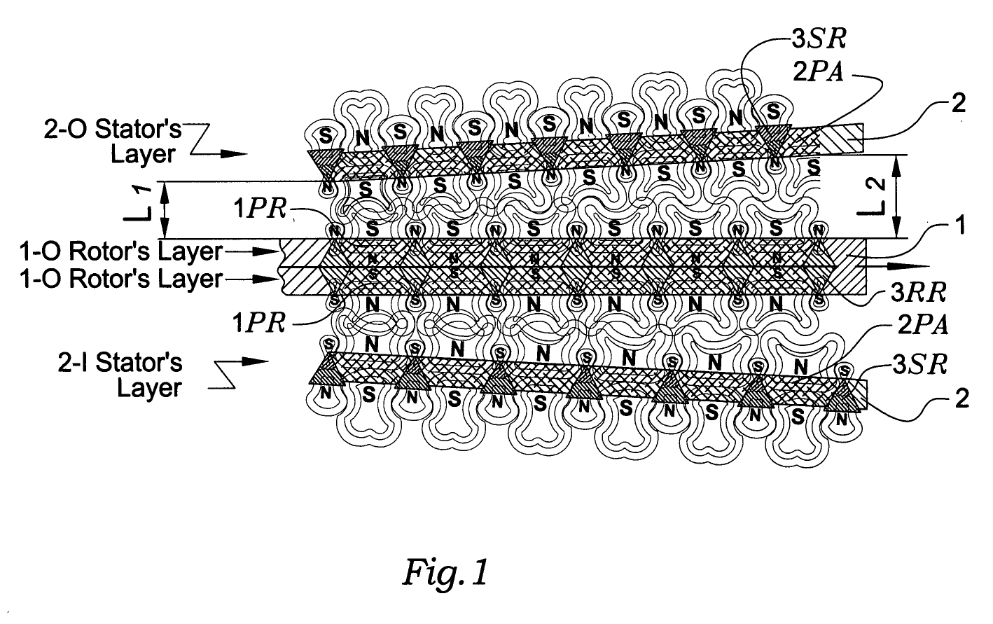

For the purpose of demonstration of the principles of the invention, the PMM is schematically illustrated on the drawing of FIG. 1, and 2. FIG. 1 exemplifies a fragment of a combination of a rotor (1), including an inner rotor assembly (1-I), and an outer rotor assembly (1-O), and a stator (2), including an inner stator assembly (2-I) surrounded by inner rotor assembly 1-I, and an outer stator assembly (2-O) surrounding outer rotor assembly 1-O. FIG.1 also shows a sample magnetic flux distribution around elements of the stator and rotor and within the air gap between them. The principles however may also be applied to a multi-rotor and multi-stator implementation as well as to a linear stator and movable armature implementation of PMM. A fragment of PMM is schematically shown on FIG. 1 in a linear view, but conditionally represents portions of annular rotor assemblies 1-I and 1-O, and plane spiral stator assemblies 2-I and 2-O, described below in a radial embodiment of PMM.

Radial Embodiment of Invented PMM, the Rotor

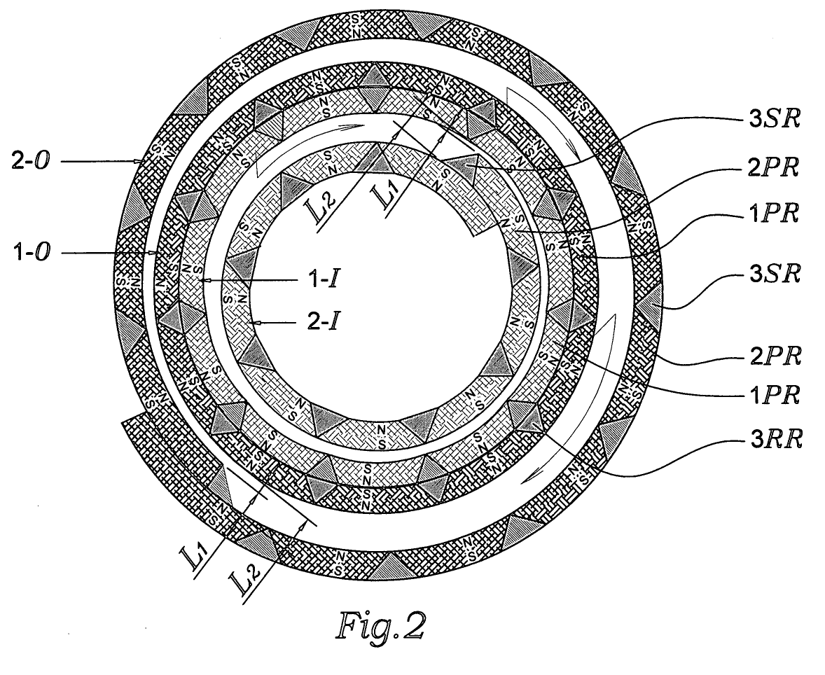

The radial embodiment of PMM includes two rotor assemblies: inner 1-I and outer 1-O, both having an annular cylindrical shape, positioned substantially in a horizontal plane, concentrically and continuously fixed to each other, as illustrated on FIG. 2, and mounted so that capable to be rotated about a substantially vertical axle pivotally secured in a coordinate system. Optionally, the assemblies may be mounted on the rotor separately (not shown herein).

Each said rotor assembly comprises a plurality of magnetic means for creation of permanent magnetic field in the form of permanent magnets (1PR) mounted on the assembly circumferentially adjacent to each other, and a plurality of separating means for redistribution of the concentration of magnetic field in the form of solid insertions (3RR) each substantially made of soft iron possessing no permanent magnetic property, but capable to acquire induced magnetism or to be magnetized where being in contact with permanent magnets. The permanent magnets 1PR and insertions 3RR are joined in a special order, described below.

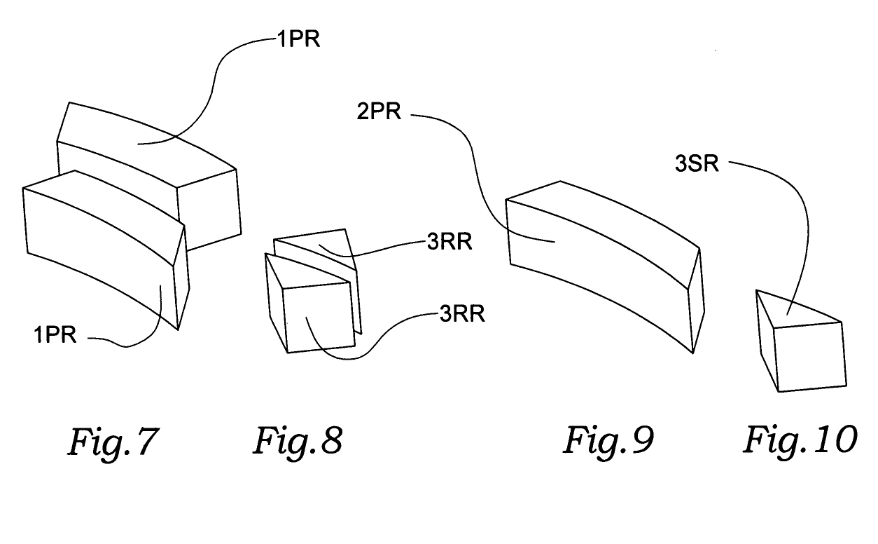

The shape of permanent magnet 1PR may be described as two annular segments, illustrated on FIG. 7, each having two substantially vertical plane side surfaces, two substantially vertical cylindrical side surfaces and two substantially horizontal and identical plane base surfaces forming “trapezium-like” figures. The outward vertical side surface of each permanent magnet 1PR is magnetized, for example, in the N-polarity, then its inward vertical side surface is magnetized in the S-polarity, as depicted on FIG. 2. Thus, in this example, the two radially adjacent annular segments representing portions of rotor assemblies 1-O and 1-I and constituting one permanent magnet 1PR, are continuously coupled by their S and N polarity poles correspondingly.

Each permanent magnet 1PR is located in immediate proximity to the two (left and right) circumferentially adjacent permanent magnets at their outermost end points of the longer bases of said trapezium-like figures of the upper and lower horizontal surfaces respectively, so that an empty space substantially in the form of a four-side prism, is left between the two adjacent permanent magnets, which four-side prism having the horizontal base surfaces each shaped as a rhomb, as shown on FIG. 7.

The shape of insertion 3RR may be described as two attached to each other three-side prisms, illustrated on FIG: 8, each having three substantially vertical plane side surfaces, and two substantially identical and horizontal plane triangle base surfaces. As the two prisms represent portions of the rotor assemblies 1-I and 1-O, they are continuously coupled to each other along the inward surface of the rotor assembly 1-O and the outward surface of the rotor assembly 1-I. Thus, in whole, the-insertion 3RR has a shape of a prism having its horizontal bases each in the form of a rhomb. The insertion 3RR essentially completely fills the inside space between each two circumferentially adjacent permanent magnets IPR

Radial Embodiment of Invented PMM, the Stator

A radial embodiment of PMM generally includes two stator assemblies preferably immovably secured in said coordinate system: the outer 2-O surrounding the rotor 1, and the inner 2-I surrounded by the rotor 1, each having a plane one-turn spiral shape, positioned substantially concentrically in the same horizontal plane as the rotor. As reflected on FIG. 2, the stator assembly 2-O comprises a plurality of magnetic means for creation of permanent magnetic field in the form of permanent magnets (2PR) peripherally adjacent to each other in a specific manner, and a plurality of separating means for redistribution of the concentration of magnetic field in the form of solid insertions (3SR) both mounted on the assembly. The permanent magnets 2PR and insertions 3SR are joined in a special order, described below.

The spiral shape of the stator assemblies 2-O (and 2-I) is performed so that the air gap measured horizontally between stator assembly 2-O (and 2-I) and rotor 1 is gradually increasing toward one (e.g. clockwise) direction, which is depicted on FIG. 2, illustrating the width (L1) of the air gap measured horizontally between the inward surface of a first stator permanent magnet and the corresponding opposite rotor permanent magnet; and the width (L2) of the air gap between the inward surface of the last permanent magnet in the spiral shape of the stator assembly 2-O and the corresponding opposite rotor permanent magnet. The further description of permanent magnets 2PR and insertions 3SR is directed to the stator assembly 2-O. The stator assembly 2-I is similar except that its location inner to the rotor reverses the orientation and magnetic polarity of the permanent magnets and insertions, reduces the respective sizes and areas of the geometrical figures of their bases comparatively to the stator assembly 2-O. Yet, a skilled artisan, using FIG. 2, should be able to easily modify the description arriving to the understanding of said relations, relative sizes, and areas of the similar geometrical figures characterizing the permanent magnets and insertions of the stator assembly 2-I.

The shape of permanent magnet 2PR may be described as an annular segment, illustrated-on FIG. 9, having two substantially vertical plane side surfaces, two substantially vertical cylindrical side surfaces representing segment portions of the whole spiral longitudinal side surfaces of the stator assembly 2-O, and two (upper and lower) substantially identical and horizontal plane base surfaces forming “trapezium-like” figures. The bases of the trapezium-like figures are curved outwardly from the center of rotor's rotation, since pertaining to the inward and outward spiral surfaces of stator assembly 2-O, which distinguishes them from a true trapezium figure. The outward vertical cylindrical side surface of each permanent magnet 2PR is magnetized, for instance, in the S-polarity, its inward vertical side surface is then magnetized in the N-polarity, as depicted on FIG. 2. Each permanent magnet 2PR is located in immediate proximity to the two adjacent permanent magnets at their outermost endpoints of the longer bases of said trapezium-like figures of the upper and lower horizontal surfaces respectively, except the first and the last magnets of the spiral assembly, so that an empty space substantially in the form of a three-side prism is left between the two adjacent permanent magnets.

The shape of insertion 3SR may be described as a three-side prism, illustrated on FIG. 10, having three substantially vertical plane side surfaces, and two substantially identical and horizontal plane triangle base surfaces. The insertion 3SR essentially completely fills said inside empty space between each two adjacent permanent magnets 2PR, except the first and the last permanent magnets of the spirally shaped stator assembly.

In other words, the permanent magnets 2PR are mounted with insertions 3SR collectively forming a continuous spiral configuration and disposed at a peripheral direction of the stator assembly 2-O, depicted on FIG. 2. The last permanent magnet with its inward surface is partially superimposed on and properly connected to the outward surface of the first permanent magnet, forming essentially one permanent magnet, called a connecting magnetic means in the form of a connecting magnet with a length greater than a critical length of permanent magnet. The critical length may be determined for an elongated permanent magnet as the minimum length of the magnet, which provides a substantially zero magnet force around the middle area of the magnet. Therefore, the connecting magnet provides a transitional zone of zero magnetic field between the field at the point of the maximum air gap L2 and the field at the point of the minimum air gap L1 of the stator assembly.

The air gap between the stator assembly 2-O and the rotor assembly 1-O increases from L1 to L2, defining an inter joint area or a critical zone of the stator assembly 2-O in the location of the connecting magnet, shown on FIG. 2.

As indicated above, the stator assembly 2-I is constructed similarly to the stator assembly 2-O. FIG. 2 shows their mutual disposition. Particularly, it can be noticed that the inter joint area of the inner stator assembly 2-I is located relatively to the inter joint area of the outer stator assembly 2-O substantially at an angle equal 180.degree. Analogously, for a three-stator assemblies implementation this angle will be substantially 120.degree., for a ‘n’-stator assemblies implementation it will be 360.degree. divided by ‘n’—the number of stator assemblies in the PMM. This important relationship of the PMM must be kept for all embodiments having two and more stator assemblies, which is further discussed in the operation section.

The other important relationship is that there must be no common multiple for the numbers of the permanent magnets mounted on the stator and rotor. An example of the relationship is shown on FIG. 2, wherein the number of permanent magnets comprising the inner stator assembly 2-I is 14, the rotor is respectively 11, and the outer stator assembly 2-O is 17.

In general, the number of permanent magnets is chosen considering the average assembly diameter and a critical length of the permanent magnet. As mentioned, the critical length may be determined for an elongated permanent magnet as the minimum length of the magnet, which provides a substantially zero magnet force around the middle area of the magnet.

Two variations of the radial embodiment were tested and proved its ability to rotate.

Axial Embodiment of Invented PMM, the Rotor

The axial embodiment of PMM comprises at least one rotor assembly disposed substantially in a horizontal plane and mounted so that capable to be rotated about a substantially vertical axle pivotally secured in a coordinate system.

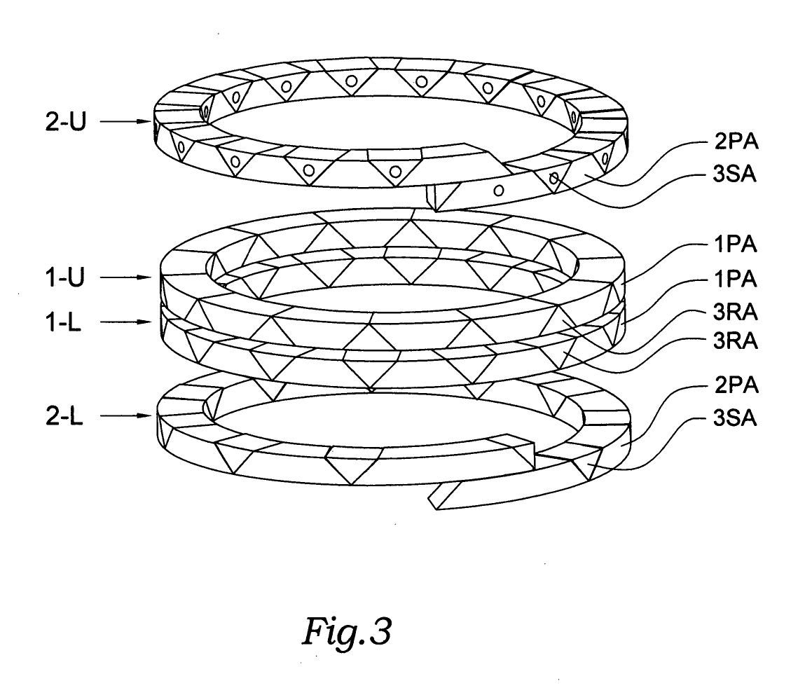

As exemplified on FIG. 3, the rotor 1 comprises two annularly shaped rotor assemblies: upper (1-U) and lower (1-L) vertically and continuously fixed to each other by the lower plane surface of 1-U and the upper plane surface of 1-L. Optionally, the rotor assemblies may be constructed separately, mounted on a common shaft, and forming a separate pair with the respective stator assembly, where each such pair has its own air gap (not shown herein).

Each said rotor assembly comprises a plurality of magnetic means for creation of permanent magnetic field in the form of permanent magnets (1PA) and a plurality of separating means for redistribution of the concentration of magnetic field in the forth of insertions (3RA). Each insertion 3RA is substantially made of soft iron possessing no permanent magnetic property, but capable to acquire induced magnetism or to be magnetized where being in contact with permanent magnets.

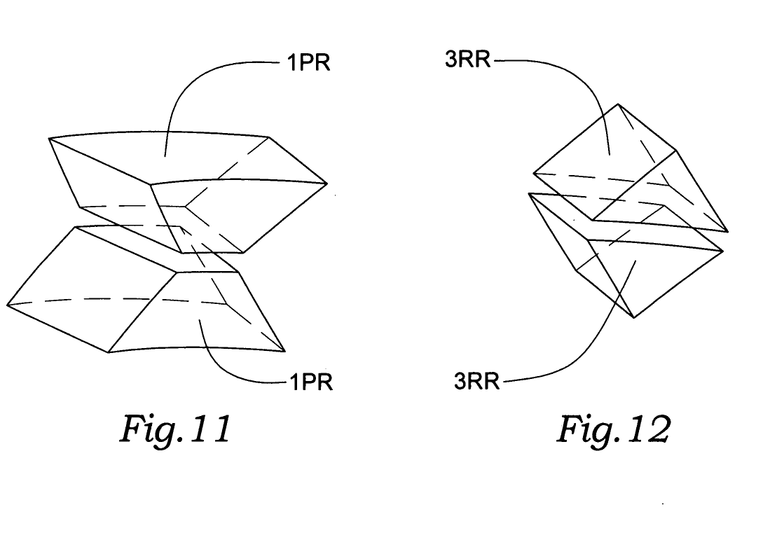

The shape of permanent magnet 1PA is essentially a doubled annular segment, including two halves in the form of annular segments: the upper and the lower, vertically coupled to each other as indicated above, illustrated on FIG. 11.

Each annular segment has two plane side surfaces substantially inclined to the horizon at an acute angle “beta”. The upper annular segment's plane sides are inclined so that the annular segment widens downwardly, the lower annular segment's plane sides are inclined so that it widens upwardly, wherein the “beta” angle has preferably the same value for all the plane sides of the annular segments.

Each annular segment has two substantially vertical annular cylindrical side surfaces: the inward cylindrical surface being part of the common annular inward surface of the rotor assembly it is mounted on, and the outward cylindrical surface being part of the common annular outward surface of the rotor assembly it is mounted on.

Each annular segment has two substantially horizontal plane base surfaces (upper and lower) forming “trapezium-like” figures with different area size (larger base surface and smaller base surface), since the annular segments are widen downwardly and upwardly as described above. Each of the “trapezium-like” figures has two curved bases with different length, situated on the aforesaid annular cylindrical side surfaces, factually on two concentrically positioned circumferences of the corresponding annular side surfaces. Therefore the “trapezium-like” figures differ from a true trapezium figure.

Each of the “trapezium-like” figures has two sides (left and right) with the same length, but oriented at an angle to each other, which angle is substantially determined by the number of permanent magnets in the assembly. The left and the right sides of the “trapezium-like” figure of the larger base surface (the upper surface of the upper assembly, and the lower surface of the lower assembly) are oriented radially to the common center of both said circumferences, which center is positioned on the vertical rotation axle in the plane of the larger base surface.

The left side of the “trapezium-like” figure, situated on the upper base surface, extends parallel to the left side of the “trapezium-like” figure, situated on the lower base:surface, the right side of the “trapezium-like” figure, situated on the upper base surface, extends parallel to the right side-Of the “trapezium-like”figure, situated on the lower base surface. The upper (smaller) base surface of the lower annular segment is continuously fixed to the lower(smaller) base surface of a the vertically adjacent upper annular segment, thereby forming one permanent magnet 1PA.

The upper base surface of each permanent magnet 1PA is magnetized, for example, in the N-polarity, then its lower base surface is magnetized in the S-polarity, as depicted on FIG. 3.

Each permanent magnet 1PA is located in immediate proximity to the two (left and right) circumferentially adjacent permanent magnets along the left and right sides of said trapezium-like figures of the upper and lower horizontal surfaces respectively, so that an empty space substantially in the form of a four-side prism, is left between the two adjacent permanent magnets, which four-side prism empty space having the vertical base surfaces each shaped as a rhomb, as shown on FIG. 11.

The shape of insertion 3RA may be described as two substantially horizontally oriented and vertically attached to each other three-side prisms, illustrated on FIG. 12, each having three substantially plane side surfaces. One of the side surfaces is positioned horizontally, and the other two are positioned at the aforesaid “beta” angle to the horizon oriented so that their line of crossing is situated on the upper (for assembly 1-U) or on the lower (for assembly 1-L) horizontal surfaces of the corresponding rotor assemblies.

Each insertion has two substantially vertically disposed and identical plane triangle base surfaces. As the two three-side prisms represent portions of the rotor assemblies 1-U and 1-L, they are continuously coupled to each other by the lower horizontal plane surface of rotor assembly 1-U and the upper horizontal plane surface of rotor assembly 1-L. Thus, in whole, the insertion 3RA has a shape of a prism having its vertical bases each in the form of a rhomb. The insertion 3RA essentially completely fills said inside empty space between each two circumferentially adjacent permanent magnets IPA.

Axial Embodiment of Invented PMM, the Stator

The axial embodiment of PMM generally includes at least one stator assembly, preferably immovably secured in said coordinate system. Herein it is exemplified and shown on FIG. 3 for two stator assemblies: a lower (2-L) stator assembly, positioned substantially below rotor assembly 1-L, and an upper (2-U) stator assembly, positioned substantially above rotor assembly 1-U, each said stator assembly having a one-turn three-dimensional spiral shape known as a helix. As reflected on FIG. 3, the stator assemblies 2-U and 2-L each-comprises a plurality of magnetic means for creation of permanent magnetic field in the form of permanent magnets (2PA) peripherally adjacent to each other in a specific manner, and a plurality of separating means for redistribution of the concentration of magnetic field in the form of solid insertions. (3SA), each substantially made of soft iron possessing no permanent magnetic property, but capable to acquire induced magnetism or to be magnetized where being in contact with permanent magnets. The permanent magnets 2PA and insertions 3SA are both mounted on the stator assemblies 2-U and 2-L and joined in a special order, described below.

The helix shape of the stator assemblies 2-U (and 2-L) is performed so that the air gap measured vertically between stator assembly 2-U (and 2-L) and rotor assembly 1-U (and respectively 1-L) is gradually increasing toward one (e.g. clockwise) direction, which is depicted on FIG. 3, illustrating the width (L1) of the air gap between the lower surface of a first permanent magnet of the stator assembly 2-U and the upper surface of the corresponding opposite permanent magnet of the rotor assembly 1-U; and the width (L2) of the air gap between the lower surface of the last permanent magnet in the helix shape of the stator assembly 2-U and the upper surface of the corresponding opposite permanent magnet of the rotor assembly 1-U.

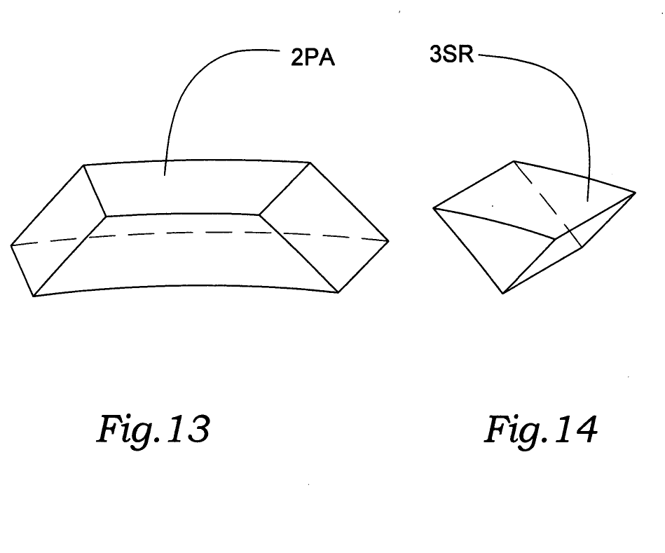

The shape of permanent magnet 2PA is essentially an annular helix segment, further shortly called AHS, illustrated on FIG. 13.

The AHS has two plane side surfaces substantially inclined at an acute angle “beta”. The AHS's plane sides are inclined so that the AHS widens downwardly (for assembly 2-U), the AHS's plane sides are inclined so that it widens upwardly (for assembly 2-L), wherein the “beta” angle has preferably the same value for all the plane sides of the AHSs.

The AHS has two substantially vertical annular cylindrical side surfaces: the inward cylindrical surface being part of the common annular inward surface of the stator assembly it is mounted on, and the outward cylindrical surface being part of the common annular outward surface of the stator assembly it is mounted on.

The AHS has two substantially parallel plane base surfaces (upper and lower) forming “trapezium-like”figures with different area size (larger base surface and smaller base surface), since the AHS is widen downwardly (for assembly 2-U), or upwardly (for assembly 2-L), as described above. Each of the “trapezium-like” figures has two curved bases with different length, situated on the aforesaid annular cylindrical side surfaces, factually on two concentrically positioned curves of the corresponding annular side surfaces. Therefore the “trapezium-like” figures differ from a true trapezium figure.

Each of the “trapezium-like” figures has two sides (left and right) with the same length, but oriented at an angle to each other, which angle is substantially determined by the number of permanent magnets in the assembly. The left and the right sides of the “trapezium-like” figure of the larger base surface (the upper surface of the lower assembly 2-L, and the lower surface of the upper assembly 2-U) are oriented radially to the common center of both said concentric curves, which center is positioned on the vertical rotation axle in the plane of the larger base surface.

The left side of the “trapezium-like” figure, situated on the upper base surface, extends parallel to the left side of the “trapezium-like” figure, situated on the lower base surface, the right side of the “trapezium-like” figure, situated on the upper base surface, extends parallel to the right side of the “trapezium-like” figure, situated on the lower base surface. The aforementioned six surfaces form one permanent magnet 2PA.

The upper base surface of each permanent magnet 2PA of stator assembly 2-L is magnetized, for example, in the N-polarity, then its lower base surface is magnetized in the S-polarity. The permanent magnets 2PA of stator assembly 2-U, therefore, will have the same orientation of the magnetic field, as depicted on FIG. 3. Accordingly, the upper base surface of rotor assembly 1-U will have the N-polarity, and the lower base surface of rotor assembly 1-L will have the S-polarity.

Each permanent magnet 2PA is located in immediate proximity to the two (left and right) peripherally adjacent permanent magnets along the left and right sides-of said trapezium-like figures of the larger (upper for 2-L and lower for 2-U) base surfaces respectively (left side-to neighbor's right side, and right side-to neighbor's left side), so that an empty space substantially in the form of a three-side prism, is left between any two adjacent permanent magnets except between the first and the last permanent magnets of assembly 2-U or 2-L, which three-side prism empty space having the vertical base surfaces each shaped-as a triangle, as shown on FIG. 13.

The shape of insertion 3SA may be described as a three-side prism essentially horizontally oriented, illustrated on FIG. 14, each having three substantially plane side surfaces. A first side surfaces is positioned on the upper surface for assembly 2-U, and on the lower surface of assembly 2-L. The other two side surfaces are positioned substantially at the “beta” angle to the first side surface oriented so that their line of crossing (the rib of the three-side prism) is situated on the lower (for assembly 2-U) or on the upper (for assembly 2-L) surfaces of the corresponding stator assemblies.

Each insertion has two substantially vertically disposed and identical plane triangle base surfaces. Thus, in whole, the insertion 3SA has a shape of a prism having its vertical bases each in the form of a triangle. The insertion 3SA essentially completely fills said inside empty space between each two peripherally adjacent permanent magnets 2PA of assemblies 2-U and 2-L except between the first and the last permanent magnets of assembly 2-U or 2-L.

In other words, the permanent magnets 2PA are mounted with insertions 3SA collectively forming a continuous spiral configuration and disposed at a peripheral direction of stator assemblies 2-U and 2-L. The last permanent magnet of both assemblies with its lower plane surface is partially superimposed on and properly connected to the upper surface of the first permanent magnet of the respective assembly, forming a connecting magnetic means in the form of a connecting permanent magnet with the zero field zone as explained in the rotational embodiment description. The air gap between the stator assembly (e.g. 2-U) and the rotor assembly (e.g. 1-U) increases from L1 to L2, defining the only inter joint area or critical zone of the stator assembly 2-U shown on FIG. 3.

As indicated-above, the stator assembly 2-L is constructed similarly to the stator assembly 2-U. FIG.3 shows their mutual disposition. Particularly, it can be noticed that the inter joint area of the inner stator assembly 2-L is located relatively to the inter-joint area of the outer stator assembly 2-U substantially at an angle equal 180.degree. Analogously, for a stator assemblies implementation it will be 360.degree. divided by ‘n’, wherein ‘n’is the number of stator assemblies. This relationship is important for the PMM, and must be kept for all embodiments having two or more stator assemblies.

The other important relationship of the PMM is that there must be no common multiple for the numbers of the permanent magnets mounted on the stator and rotor.

In general, the number of permanent magnets is chosen considering the average assembly diameter and the critical length of the permanent magnet, which can be determined as mentioned earlier in the description of the radial embodiment.

Operation of Radial Embodiment of Invented PMM

The operational principles and means are exemplified below with the application to the radial embodiment, though they may be similarly applied to the axial embodiment with peculiarities of its construction being insubstantial for the application of said principles and disclosed in the respective sections of the description. However, the operation of the compressional embodiment has important differences, and will be discussed herein further.

The permanent magnets 1PR and 2PR of the rotor 1 and stator 2 assemblies, shown on FIG. 1 and 2, facing each other (the inward surface of 1-I and the outward surface of 2-I, as well as the outward surface of 1-O and the inward surface of 2-O) are magnetized with the same polarity and create a predominant mono-polar (e.g. N) magnetic field zone in the air gap. The soft iron insertions 3RR and 3SR provide a redistribution of the concentration of magnetic flux illustrated on FIG. 1, so that a zone of the opposite polarity (e.g. S) will be essentially restricted to a predetermined relatively small area in the proximity of the insertion's rib (the crossing line of two sides of said three-side prism of 3RR or 3SR) situated on the respective assembly's surface facing the air gap. The air gaps between rotor 1 and stator 2 should have a minimal possible width to achieve a greater rotational torque.

The concentration of magnetic fields of the predominant mono-polar zones in the air gaps between the stator 2 and rotor 1 decreases in the direction of widening of the air gaps, which creates a repulsive force applied to the rotor's permanent magnets-1PR toward said direction, and therefore creates a rotatable torque of the radial PMM. As indicated above, there is the inter joint area or critical zone (only one for one spiral stator assembly), where the repulsive force generally changes its direction to the contrary.

The above described connecting magnet, joining the first and last magnets 2PR of the spiral stator assembly, serves to substantially reduce the negative (i.e: opposite to the rotation direction) repulsive force, providing a transitional zone of zero magnetic field between the field at the point of the maximum air gap L2 and the field at the point of the minimum air gap L1 of the stator assembly.

After a rotor magnet 1PR passes the zero zone, the remaining portion of the connecting stator magnet (further called a critical portion) still causes the negative repulsive force decelerating the magnet, until the half point of the rotor magnet 1PR passes the critical portion of the connecting magnet. At this point the positive motive force (toward the rotation direction) will be applied to the rotor magnet 1PR further accelerating it.

An additional step to reduce the negative repulsive force is provided by positioning the inter-joint areas of two stator assemblies substantially at an angle equal 180.degree., as indicated earlier. For a construction with ‘n’ stator assemblies the angle must be equal to 360.degree. divided by ‘n’. The numbers of permanent magnets of the rotor and stator assemblies of the PMM must not have a common multiple. This step results in a reduction of the negative repulsive force applied to the rotor, since it excludes the passing of the critical portions of two connecting magnets, mounted on the different stator assemblies, by two rotor magnets simultaneously. On the contrary, while one of the two rotor magnets positioned opposite (at 180.degree.) to each other mounted on one rotor assembly (e.g. 1-O), enters the critical portion of one stator assembly (2-O), the second (opposite) rotor magnet of the other rotor assembly (1-I) has already passed the critical portion of the other stator assembly (2-I) and starts accelerating, or vice versa. Therefore, the PMM provides continuous rotation of the rotor.

Compressional Embodiment of Invented PMM, Description and Operation

The third invented embodiment is a compressional PMM, wherein the rotor and stator are essentially performed in the same manner as in the axial embodiment, except that the rotor and the upper stator assembly are made substantially vertically displaceable, which displacement can be regulated by a special mechanism.

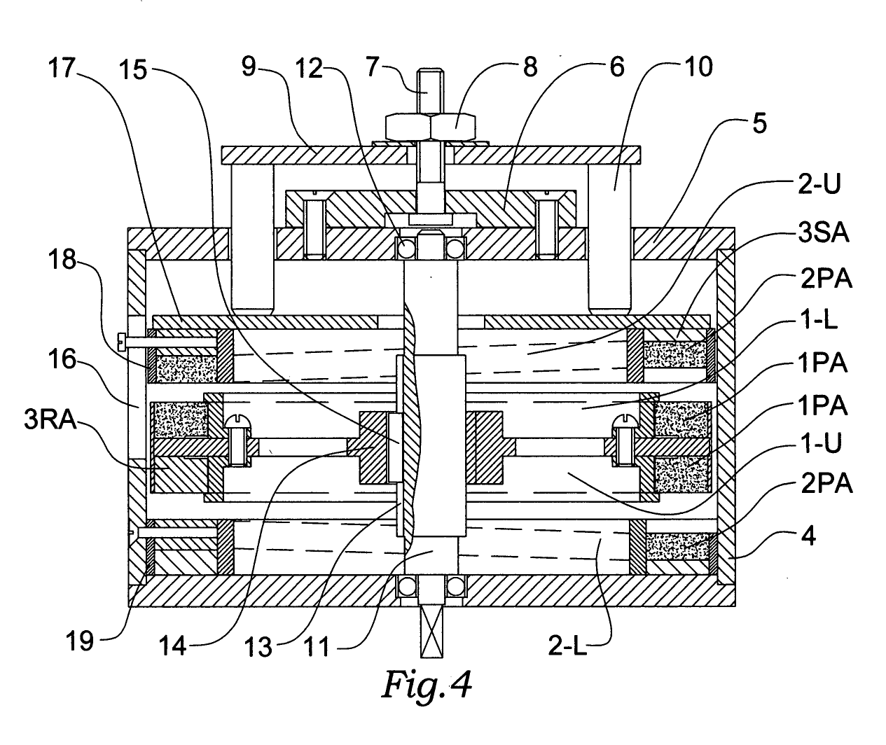

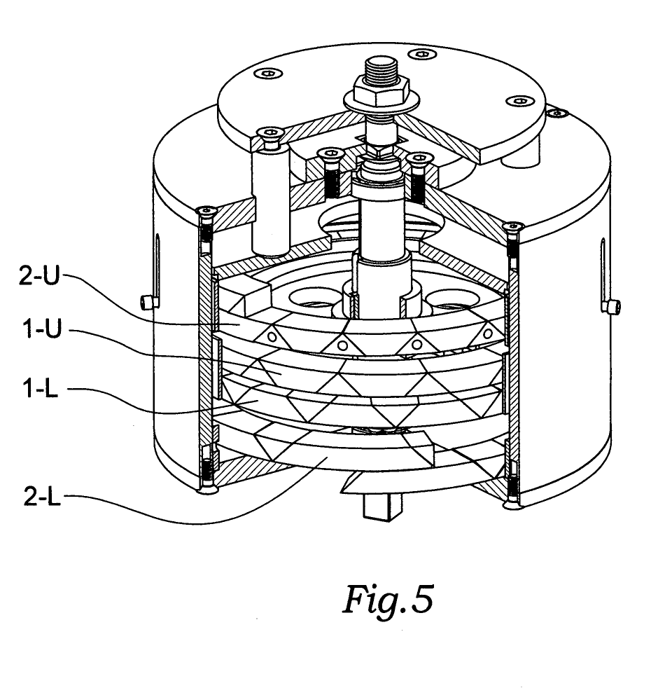

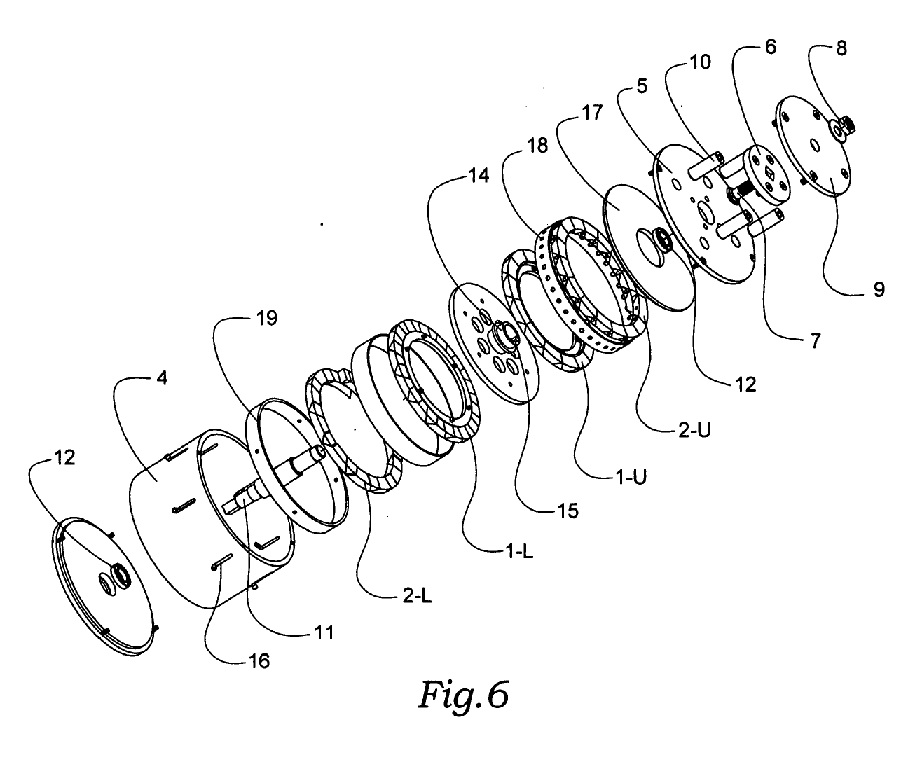

The compressional PMM is illustrated on FIGS. 4 and 5, and comprises: a casing (4); with an upper cover (5) made as the top of casing 4, having a plurality (in this example—four) of holes; a lower flange (6) immovably fixed to cover 5; a bolt (7) immovably joined to lower flange 6 and disposed substantially vertically with its head positioned downwardly and its threads positioned on the upper portion of bolt 7; a nut (8) with the treads paired to the threads of bolt 7, the nut is properly placed on the bolt.

The compressional PMM comprises an upper flange (9) fixed on the upper surface of cover 5 and having a central through hole in which hole bolt 7 is inserted, nut 8 is capable to come in direct contact with the upper surface of upper flange 9, so that flange 9 may displace being affected by a pressure received from nut 8; a plurality (in this example—four) of pins (10) vertically positioned and immovably attached to the underside surface of upper flange 9, which pins are capable to vertically slide upward and downward through the holes of cover 5;

The compressional PMM comprises a shaft (11) substantially vertically and pivotally mounted on an upper and a lower bearings (12), wherein the upper bearing is mounted preferably at the center of cover 5, and the lower bearing is mounted preferably at the center of the bottom of casing 4; a plurality (in this example—four) of elongated shaft keyway (13) made on the surface of shaft 11 substantially parallel to its vertical axe, a nave,(14) substantially horizontally disposed and connected to shaft 11 by a straight sunk key (15), where key 15 are slidely displaceable on shaft keyway 13, key 15 are internally attached to the central hole of nave 14, which central hole is used to insert shaft 11, so that nave 14 is capable to vertically slide upward and downward relatively to shaft 11 wherein each key 15 is guided by one shaft keyway 13.

The compressional PMM comprises the lower stator assembly 2-L (earlier described in the axial embodiment) peripherally mounted on a lower support rim (19) immovably fixed to the bottom of casing 4, rotor assemblies 1-L and 1-U (earlier described in the axial embodiment, vertically coupled to each other) peripherally mounted on nave 14; upper stator assembly 2-U (earlier described in the axial embodiment) peripherally mounted on an upper support rim (18) slidely disposed on casing grooves (16) that are vertically made on the walls of casing 4; disk (17) positioned above the upper surface of stator assembly 2-U, wherein disk 17 is capable to receive a pressure applied to nut S and transmitted by upper flange 9, and pins 10, and to further transmit the pressure to the upper stator assembly 2-U.

The above described elements of the compressional embodiment are conditionally united into four functional groups: the rotor assemblies 1-L and 1-U; the stator assemblies 2-L and 2-U; supporting means for montage and support of the stator and rotor assemblies, compressional means for applying a preferably vertical downward pressure on the upper stator assembly 2-U narrowing the air gap between assemblies 2-U and 1-U, and therefore also narrowing the air gap between assemblies 1-L and 2-L, since the pressure will be distributed between the two air gaps, which will cause an increase of the rotational torque.

The supporting means comprise: casing 4 with casing grooves 16, cover 5, shaft 11 with shaft keyway 13, upper and lower bearings 12, nave 14 with straight sunk key 15, upper support rim 18, and lower support rim 19. The compressional means comprise: lower flange 6, upper flange 9 with pins 10, bolt 7, nut 8, and disk 17.

The operation of the compressional PMM is mainly based on the principles previously discussed for the radial embodiment, though additionally deploying aforesaid parts providing an effect of compression of the magnetic field in the air gaps between the rotor and stator assemblies. As reflected on FIG. 4, disk 17 with upper flange 9, pins 10, and stator assembly 2-U displace downward due to the gravitation force until the increasing repulsive magnetic force in the air gap between assemblies 2-U and 1-U compensates the gravitation force. Rotor 1 with nave 14 and shaft 11 start rotating around the vertical axle according to the effects described above for the radial PMM.

Since the motive force and rotatable torque produced by the PMM depends on the concentration of the magnetic flux in the air gap between the stator and the rotor, a reduction of the width of the air gap causes an increase of the flux concentration, therefore increasing the difference between the maximum and minimum concentrations within the air gap, and thus magnifies the rotational torque of the rotor. For example, if the maximum and the minimum concentrations increase in two times due to the compression, the difference of them increases respectively in two times, which should double the rotational torque.

It is therefore possible to turn down nut 8 imposing a pressure on upper flange 9, pins 10, disk 17, to additionally displace assembly 2-U downward for further decreasing the air gap and increasing the concentration of flux and the rotational torque of the PMM. Consequently, the compressional embodiment enables the operator to regulate the speed and rotational torque of the permanent magnetic motor.

I claim

1. A permanent magnet motor comprising:
a rotor including a number of rotor assemblies capable to rotate around a substantially, vertical axle immovably disposed in a coordinate system,
a stator including a number of stator assemblies positioned in the coordinate system so that incapable to rotate around said axle;
each rotor assembly comprising
a plurality of magnetic means for creation of permanent magnetic field consequently and circumferentially, mounted on the peripheral surface of said rotor assembly, so that having a space between each other, and
a plurality of separating means for redistribution of the concentration of magnetic field, each mounted so that substantially filling the space between the magnetic means of said rotor assembly;
each stator assembly comprising
a plurality of magnetic means for creation of permanent magnetic field consequently mounted on the peripheral surface of said stator assembly, so that having a space between each other, and
a plurality of separating means for redistribution of the concentration of magnetic field, each mounted so that substantially filling the space between the magnetic means of said stator assembly, except between the first and the last magnetic means, wherein the last magnetic means and the first magnetic means joined forming a connecting magnetic means;
the rotor assemblies and the stator assemblies mutually disposed relatively to each other so that forming at least one pair having an air gap between the two assemblies constituting the pair, which air gap gradually and continuously widening in the direction from the first magnetic means of the stator assembly of said pair to the last magnetic means of this assembly;
wherein the stator assembly magnetic means magnetized in the same polarity as the correspondingly facing opposite rotor assembly magnetic means of said pair, and the number of magnetic means of the stator assembly and the number of magnetic means of the rotor assembly of said pair having no common multiple.

2. The permanent magnet motor in claim 1, wherein
said permanent motor having a plurality of stator assemblies, thereby forming more than one pair of facing to each other stator and rotor assemblies;
the number of magnetic means mounted on any two stator assemblies having no common multiple; and
the stator assemblies so mutually positioned that their connecting magnetic means disposed at an angle equal to 360.degree. divided by the number of the stator assemblies.

3. The permanent magnet motor in claim 1, wherein
the stator assembly each substantially shaped as a horizontally oriented spiral;
the rotor assembly each substantially shaped as a cylinder;
said rotor and stator assemblies disposed substantially concentrically in a horizontal plane;
said air gap measured horizontally;
said magnetic means of the rotor and stator assemblies each performed as a permanent magnet substantially shaped as an annular segment, having two plane vertical sides, two cylindrical vertical sides, and two horizontal bases;
said separating means of the rotor and stator assemblies each performed as an insertion made of soft iron and substantially shaped as a three-side prism positioned vertically;
said connecting magnetic means of each stator assembly performed as a connecting magnet, formed by the last permanent magnet of the stator assembly partially superimposed with its inward surface on and properly connected to the outward surface of the first permanent magnet of said assembly, wherein the length of the connecting magnet being greater than the critical length of magnet;
the left and right sides of each rotor assembly permanent magnet joined by the respective right and left sides of the two adjacent insertions separating two neighboring permanent magnets; and
the left and right sides of each stator assembly permanent magnet joined by the respective right and left sides of the two adjacent insertions separating two neighboring permanent magnets, except the last and the first permanent magnets of the assembly.

4. The permanent magnet motor in claim 3, wherein
said permanent motor having a plurality of stator assemblies;
said permanent motor comprising more than one pair of radially facing to each other stator and rotor assemblies;
the number of permanent magnets mounted on any two stator assemblies having no common multiple; and
the stator assemblies so mutually positioned that their connecting magnets disposed at an angle equal to 360.degree. divided by the number of the stator assemblies.

5. The permanent magnet motor in claim 1, wherein
the stator assemblies each substantially shaped as a helix;
the rotor assembly each substantially cylindrically shaped;
the stator and rotor assemblies disposed so as being substantially centered on said vertical axle, vertically spaced from each other;
said air gap measured vertically;
said magnetic means of the rotor and stator assemblies each performed as a permanent magnet substantially shaped as an annular segment having two skewed plane sides where the upper line of each plane side extending parallel to the corresponding lower line of the plane side and the longer of those two lines oriented radially to the annular center in the horizontal plane containing said longer line, said annular segment having two cylindrical vertical sides, and two horizontal bases;
said separating means of the rotor and stator assemblies each performed as an insertion made of soft iron and substantially shaped as a three-side prism positioned horizontally and having a left, right, and horizontal plane sides;
said connecting magnetic means of each stator assembly performed as a connecting magnet, formed by the last permanent magnet of the stator assembly partially superimposed with its lower surface on and properly connected to the upper surface of the first permanent magnet of said assembly, wherein the length of the connecting magnet being greater than the critical length of magnet;
the left and right sides of each rotor assembly permanent magnet joined by the respective right and left sides of the two adjacent insertions separating two neighboring permanent magnets; and
the left and right sides of each stator assembly permanent magnet joined by the respective right and left sides of the two adjacent insertions separating two neighboring permanent magnets, except the last and the first permanent magnets of the assembly.

6. The permanent magnet motor in claim 5, wherein
said permanent motor having a plurality of stator assemblies;
said permanent motor comprising more than one pair of vertically facing to each other stator and rotor assemblies;
the number of permanent magnets mounted on any two stator assemblies having no common multiple; and
the stator assemblies so mutually positioned that their connecting magnets disposed at an angle equal to 360.degree. divided by the number of the stator assemblies.

7. The permanent magnet motor in claim 6, wherein
said permanent motor comprising
supporting means for montage and support of the stator and rotor assemblies;
two stator assemblies: an upper stator assembly positioned above the rotor and a lower stator assembly positioned below the rotor, said upper and lower stator assemblies cooperating with and supported by said supporting means;
two rotor assemblies: an upperrotor assembly with its upper surface vertically facing the lower surface of the upper stator assembly, and a lower rotor assembly with its lower surface vertically facing the upper surface of the lower stator assembly, said upper and lower rotor assemblies cooperating with and supported by said supporting means;
said permanent motor further comprising compressional means for applying a preferably vertical downward pressure on the upper stator assembly narrowing the air gap between the upper stator and the upper rotor assemblies, said compressional means cooperating with and supported by said supporting means.

8. The permanent magnet motor in claim 7, wherein said supporting means comprising:
a casing having substantially vertical walls with a plurality of elongated casing grooves made substantially vertically on the walls,
a cover made as the top of the casing having a plurality of cover holes,
a substantially vertically disposed shaft with a shaft keyway on its surface made substantially vertically,
an upper bearing mounted substantially in the center of the cover,
a lower bearing mounted substantially in the center of the bottom of the casing, said lower and upper bearings rotatably supporting the shaft,
a nave having a central hole used to insert the shaft,
a key internally attached to the central hole of the nave, wherein key slidely displaceable on one of the shaft keyway so that the nave capable to vertically slide along the shaft guided by said shaft keyway,
the upper and lower rotor assemblies mounted on the peripheral surface of said nave,
an upper support rim with the upper stator assembly mounted on it, said upper support rim adapted to be capable of vertically sliding guided by said casing grooves, and
a lower support rim with the lower stator assembly mounted on it and substantially immovably fixed to the bottom of the casing;
said compressional means comprising:
a lower flange immovably fixed to the cover,
a bolt, with its head positioned downwardly, immovably joined to the lower flange and disposed substantially vertically,
an upper flange having a central through hole wherein said bolt being inserted,
a nut properly placed on the bolt above the upper flange, capable of directly contacting the upper surface of said upper flange,
a plurality of pins vertically positioned and immovably fixed to the underside of the upper flange, said pins capable to vertically slide through the cover holes, and
a disk positioned above the upper surface of the upper stator assembly, wherein the disk capable to receive a pressure applied to the nut and transmitted by the upper flange and the pins onto the disk, and further transmit the pressure to the upper stator assembly.
